(19) United States
(12) Patent Application Publication
(10) Pub. No.: US 2017/0291108 A1
(43) Pub. Date: Oct. 12, 2017

(54) METHOD FOR CONTROLLING AUTOMATIC ATTACK OF USER CHARACTER

(71) Applicant: DEXINT GAMES Inc., Seoul (KR)

(72) Inventor: Jae Ho KIM, Seoul (KR)

(21) Appl. No.: 15/484,057

(22) Filed: Apr. 10, 2017

(30) Foreign Application Priority Data
Apr. 11, 2016 (KR) 10-2016-0044302

(51) Int. Cl. A63F 13/56; A63F 13/525; A63F 13/58; A63F 13/35

(52) U.S. Cl. CPC A63F 13/56; A63F 13/35; A63F 13/525; A63F 13/58

(57) ABSTRACT

Disclosed is a method for controlling an automatic attack of a user character. The method is performed by a game server, and the game server provides an online game service to a mobile terminal connected to the game server through a network and the mobile terminal does not include a user interface for controlling a basic attack of the user character. The method includes identifying whether an enemy character entered a detection range of the user character, wherein the detection range is a range that extends from a basic attack range corresponding to a range in which the basic attack of the user character is allowed, and when it is identified that the enemy character entered the detection range but did not enter the basic attack range, moving the user character such that the user character chases the enemy character to perform a basic attack on the enemy character.

### CROSS-REFERENCE TO RELATED APPLICATIONS

A claim for priority under 35 U.S.C. §119 is made to Korean Patent Application No. 10-2016-0044302 filed Apr. 11, 2016, in the Korean Intellectual Property Office, the entire contents of which are hereby incorporated by reference.

### BACKGROUND

Embodiments of the inventive concept described herein relate a method for controlling an automatic attack of a user character, and more particularly, to a method for controlling an automatic attack of a user, which may be provided to an online service performed by a mobile terminal connected through a network.

As online game services have been increasingly used in the game markets due to distribution of the Internet, for example, games pertaining to massively multi-player online role playing games (MMORPGs), which several hundreds or thousands of users may access at the same time to enjoy the games, have been increasingly released.

In recent years, as mobile terminals, such as smartphones and tablet PCs, have been rapidly distributed, the online game markets have grown again. However, as compared with the online game markets using conventional personal computer (PCs), the entry barriers of the online game markets using mobile terminals are relatively low so that the competitions become severer.

Accordingly, the gamer manufactures pay attention to increase convenience of manipulation of the mobile games in order to induce more users to the online games.

### PRIOR TECHNICAL DOCUMENTS

### Patent Documents

Korean Patent Application Publication No. 10-2014-0122610

The mobile terminals may provide only the screens of limited sizes to the users to secure mobility. Accordingly, the user interfaces displayed on the screens to control the user characters may be spatially restricted. For example, it may not be easily for the users to consistently touch small buttons of the user interfaces so that the users may perform basic attacks of the user characters,.

Further, skill attacks occupy considerable portions of interest factors of the online game services, but the users cannot enjoy the interests of the corresponding games as they cannot concentrate their attentions on the skill attacks due to the performance of the basic attacks.

Accordingly, it is urgent to improve the game environments so that the users may concentrate their attentions on the essential parts of the games without feeling inconveniences of the narrow user interfaces.

### SUMMARY

Embodiments of the inventive concept provide a method for controlling an automatic attack of a user character, by which a basic attack of the user character may be automatically performed while factors for controlling the basic attack of the user character are excluded from a user interface.

The technical objects of the inventive concept are not limited to the above-mentioned ones, and the other unmentioned technical objects will become apparent to those skilled in the art from the following description.

In accordance with an aspect of the inventive concept, there is provided a method for controlling an automatic attack of a user character, the method being performed by a game server, wherein the game server provides an online game service to a mobile terminal connected to the game server through a network and the mobile terminal does not include a user interface for controlling a basic attack of the user character, the method including identifying whether an enemy character entered a detection range of the user character, wherein the detection range is a range that extends from a basic attack range corresponding to a range in which the basic attack of the user character is allowed, and when it is identified that the enemy character entered the detection range but did not enter the basic attack range, moving the user character such that the user character chases the enemy character to perform a basic attack on the enemy character.

Detailed items of the other embodiments are included in the detailed description and the accompanying drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram schematically illustrating an exemplary system that may be provided with a method of controlling an automatic attack of a user character according to an embodiment of the inventive concept;

FIG. 2 is a block diagram schematically illustrating a detailed configuration of the game server of FIG. 1;

FIG. 3 is a schematic view illustrating a recognition range, a detection range, and a basic attack range of FIG. 2;

FIG. 4 is a flowchart schematically illustrating a process of processing a method of controlling an automatic attack of a user character according to an embodiment of the inventive concept; and

FIGS. 5A, 5B, 5C and 5D are reference views for explaining the process of processing the method of controlling an automatic attack of a user character according to an embodiment of the inventive concept.

### DETAILED DESCRIPTION

Hereinafter, exemplary embodiments of the inventive concept will be described in detail with reference to the accompanying drawings. The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept is provided to make the disclosure of the inventive concept complete and fully inform those skilled in the art to which the inventive concept pertains of the scope of the inventive concept.

Although the terms, such as first and second, are used to describe various elements, components, and/or sections, it is apparent that the elements, components, and/or sections are not limited by the terms. The terms are used simply to distinguish one element, component, or section from another one. Accordingly, it is apparent that a first element, a first component, or a first section mentioned below may be a second element, a second component, or a second section without departing from the spirit of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. The same reference numerals denote the same elements throughout the specification.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

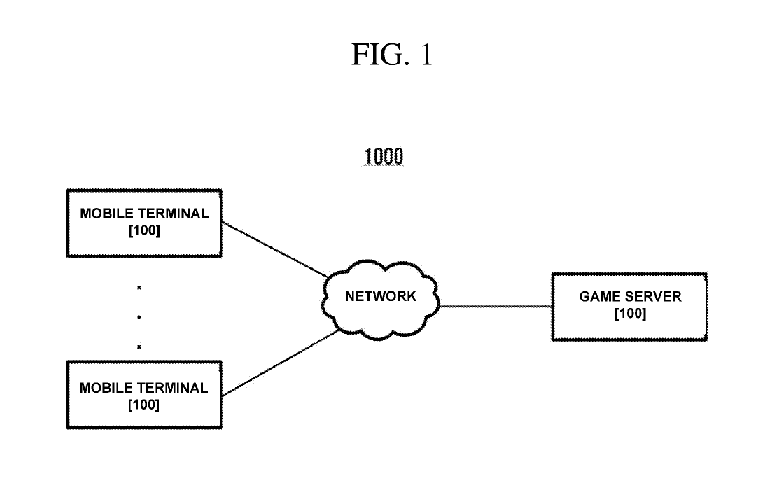

FIG. 1 is a block diagram schematically illustrating an exemplary system that may be provided with a method of controlling an automatic attack of a user character according to an embodiment of the inventive concept.

Referring to FIG. 1, an exemplary system 1000 includes a plurality of mobile terminals 100 and a game server 200. Although FIG. 1 illustrates only one game server 200, the inventive concept is not limited thereto, but the system 1000 may be modified to include a suitable number of game servers 200 according to an embodiment. Further, the game server 200 may be divided into a plurality of servers. Further, according to an embodiment, the system 1000 may be modified to further include an arbitrary component that is not illustrated in FIG. 1, and for example, a client terminal (not illustrated) that does not have a mobile attribute may be included in the system 100 but the inventive concept is not limited thereto.

A plurality of mobile terminals 100 and a game server 200 are connected to each other through a network. The network may have various scales, communication schemes, and topologies. The network may include one or more lower networks. The plurality of mobile terminals 100 and the game server 200 may transmit and receive various information and/or data.

The mobile terminals 100 refer to computer systems used by users who use an online game service. For example, the mobile terminals 100 may be computer systems, such as smartphones, personal digital assistants (PDAs), tablets, and notebooks, which have mobile attributes, but the inventive concept is not limited thereto and the mobile terminals 100 may include suitable computer systems that may transmit and receive various information and/or data with the game server 200. The users may transmit various information and/or data to the game server 200 by manipulating the mobile terminals 100, and may receive various information and/or data from the game server 200.

Meanwhile, the users may control user characters through user interfaces while using an online game service through the mobile terminals 100, and the user interfaces may be displayed such that the users may manipulate the user interfaces on the displays of the mobile terminals 100 but the inventive concept is not limited thereto. However, the mobile terminals 100 do not include user interfaces for controlling basic attacks of the user characters.

Here, the user characters are game characters controlled by the users in the online game service through the mobile terminals 100, and the basic attacks correspond to attack functions which the user characters may perform to attack enemy characters even when there is no separation setting and are contrasted with skill attacks that may be used only when there are separate settings by the users. Accordingly, the basic attacks may be performed even though there is no input for the basic attacks by the mobile terminals 100, whereas the skill attacks may be performed only when there are inputs for the skill attacks by the mobile terminals 100.

Further, the fact that the mobile terminals 100 do not include user interfaces for controlling the basic attacks of the user characters may mean that buttons for controlling the basic attacks of the user characters are not included in the user interfaces of the mobile terminals 100. However, because the basic attacks of the user characters may be automatically controlled through a method of controlling an automatic attack of the game server 200 in the embodiment of the inventive concept, there is no inconvenience of the users due to absence of user interfaces for controlling basic attacks of the user characters and rather an environment, in which the users may concentrate his or her attention on essential interests of the online game service, may be provided in that the users may concentrate his or her attention on the game strategies and skill attacks.

However, although a user may perform a control such that a user character compulsorily performs a basic attack on a specific enemy character, by touching the corresponding enemy character on a display of a mobile terminal 100, the method for controlling an automatic attack according to the embodiment of the inventive concept may be applied to a situation other than a situation in which a basic attack is performed by targeting a specific enemy character.

The game server 200 provides an online game service to the plurality of mobile terminals 100 connected to each other through a network. The game server 200 performs the method for controlling an automatic attack of a user character according to the embodiment of the inventive concept when an online game service is provided to the plurality of mobile terminals 100.

For example, the game server 200 may identify whether an enemy character entered a detection range of the user character, and may move the user character such that the user character chases the enemy character to perform a basic attack on the enemy character when it is identified that the enemy character entered the detection range but did not enter a basic attack range, and may perform a control such that the movement of the user character is stopped and the user character performs a basic attack on the enemy character when the enemy character enters the basic attack range after the user character is moved.

Here, the detection range may be a range in which the user character may chase the enemy character when the enemy character entered the corresponding range, the basic attack range may be a range in which a basic attack may be made by the user character, and the detection range may be a range that extends from the basic attack range, which will be described below in detail.

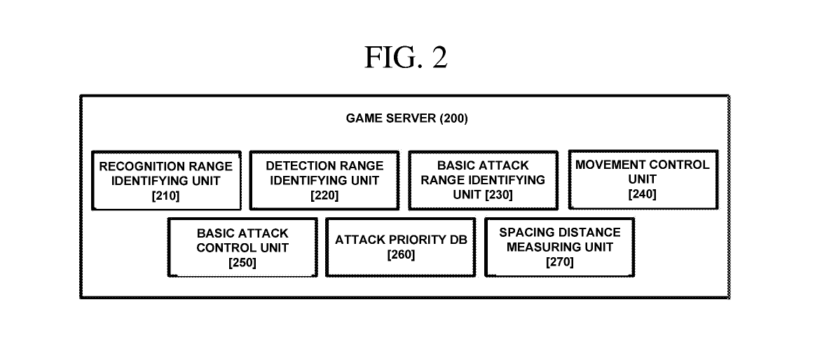

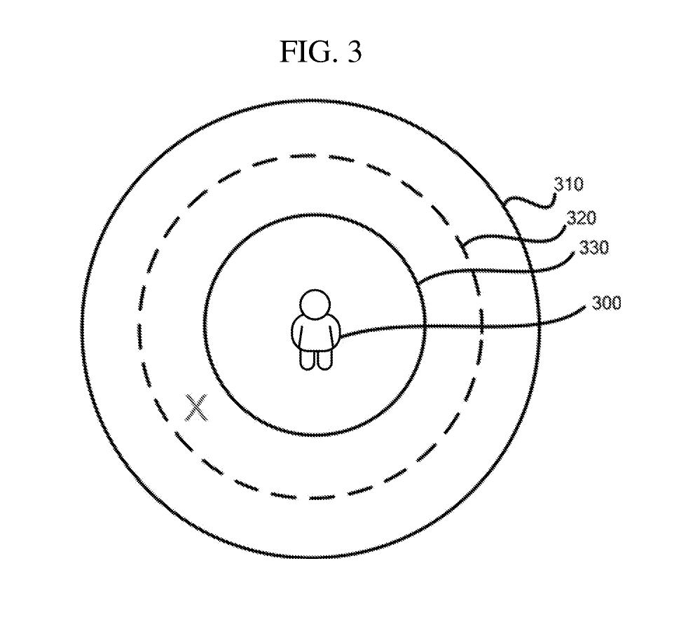

Hereinafter, a configuration of the game server 200 will be described with reference to FIGS. 2 and 3.

FIG. 2 is a block diagram schematically illustrating a detailed configuration of the game server of FIG. 1. FIG. 3 is a schematic view illustrating a recognition range, a detection range, and a basic attack range of FIG. 2. In detail, FIG. 2 may be a view schematically illustrating a configuration of an automatic attack control system of the game server of FIG. 1, for performing the method of controlling an automatic attack.

Referring to FIG. 2, the game server 200 may include a recognition range identifying unit 210, a detection range identifying unit 220, a basic attack range identifying unit 230, a movement control unit 240, a basic attack control unit 250, an attack priority database 260, and a spacing distance measuring unit 270. However, the components of FIG. 2 are not essential, and the game server 200 may be modified to further include some components, which are not illustrated in FIG. 2, or not to include some of the components of FIG. 2 according to embodiments.

The recognition range identifying unit 210 may identify whether an enemy character entered the recognition range of the user character. Here, the recognition range may refer to a range of a field of view, in which the user character may recognize another object in a map in which the user character operates.

Referring to FIG. 3, when the enemy character is outside the recognition range 310, the user character cannot recognize existence of the corresponding enemy character, and a motion of the corresponding enemy character may not be displayed in the map in which the user character operates. That is, the user character may recognize an enemy character that is identified to be present in the recognition range 310, by the recognition range identifying unit 210, and only the enemy character may be displayed in the map in which the user character operates.

The recognition range 310 may be a range that extends from the detection range 320, and the detection range 320 and the basic attack range 330 may be included in the recognition range 310. In the method for controlling an automatic attack according to the inventive concept, because all recognized enemy characters are not chased but only an enemy located close to the detection range 320 may be chased, by separating the recognition range 310 and the detection range 320, the user character may efficiently perform a basic attack.

The detection range identifying unit 220 may identify whether an enemy character entered the detection range of the user character, and the basic attack range identifying unit 230 may identify whether the enemy character entered a range in which a basic attack of the user character may be performed.

For example, referring to FIG. 3, the detection range 320 and the basic attack range 330 may be determined based on the user character 300, and the detection range 320 and the basic attack range 330 may be fixed based on the type of the user character 300, but the inventive concept is not limited thereto and the detection range 320 and the basic attack range 330 may vary based on the ability value of the user character 300.

Meanwhile, the detection range 320 may be a range that extends from the basic attack range 330. Accordingly, as long as an enemy character is located within the detection range (for example, location X) even though the corresponding enemy character is located outside the basic attack range 330, the user character 300 may chase the enemy character. Further, if the distance between the user character 300 and the enemy character becomes shorter so that the enemy character enters the basic attack range 330 as a result of the chasing of the user character 300, the user character 300 may perform a basic attack on the enemy character.

The movement control unit 240 may control the movement of the user character to automatically control the basic attack of the user character. For example, when the enemy character entered the detection range but did not enter the basic attack range, the user character may be moved to chase the enemy character to perform a basic attack on the enemy character. Further, when the enemy character deviates from the recognition range while the user character moves to chase the enemy character, the chasing of the enemy character by the user character may be stopped, and when the enemy character enters the basic attack range as a result of the movement of the user character in some embodiments, the movement of the user character may be stopped to perform a basic attack on the enemy character.

Further, when a plurality of the enemy characters enter the detection range, the movement control unit 240 may determine the priority of one of the enemy characters, which is to be chased by the user character. For example, when a plurality of enemy characters entered the detection range but did not enter the basic attack range, the movement control unit 240 may move the user character such that one of the plurality of enemy characters, which entered the detection range first, may be chased.

When the enemy character enters the basic attack range of the user character, the basic attack control unit 250 may control the user character to perform a basic attack on the enemy character. Meanwhile, when a plurality of enemy characters entered the basic attack range, the basic attack control unit 24 may perform a control such that the user character performs a basic attack on one of the enemy characters, which is determined to be attacked first in sequential consideration of types of the characters and distances between the user character and the enemy characters.

In detail, the basic attack control unit 250 may determine one of the plurality of characters, which is to be attacked first, in consideration of a specific attack priority based on the types of the enemy characters, and when the number of enemy characters, which are to be attacked first, is plural, may determine one of the enemy characters, which is closest to the user character, as an enemy character, which is to be attacked first.

The attack priority database 260 may include information on a specific attack priority based on the type of the enemy character, which is utilized when an enemy character, which is to be attacked first, is determined by the basic attack control unit 250. For example, the attack priority may be determined based on the types of the enemy characters as follows, but the inventive concept is not limited thereto.

Iron man character>Minion character>Tower character>Inhibiter character

The spacing distance measuring unit 270 may measure a distance between the user character and an enemy character, and the corresponding information may be utilized when the basic attack control unit 250 determines an enemy character, which is to be attacked first.

Hereinafter, a process of processing the method of controlling an automatic attack of a user character according to the embodiment of the inventive concept will be described.

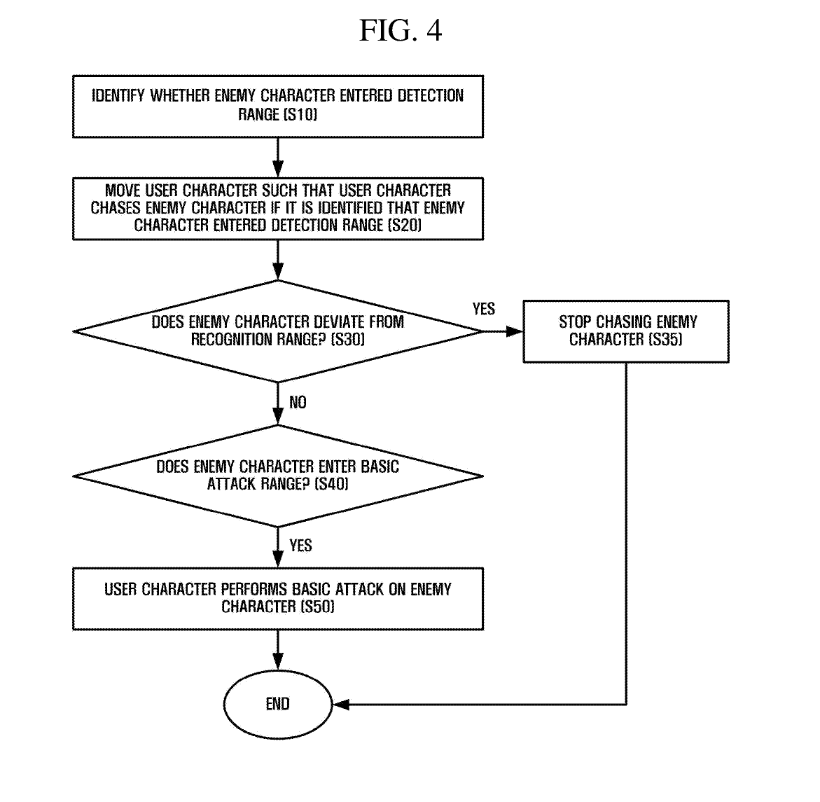

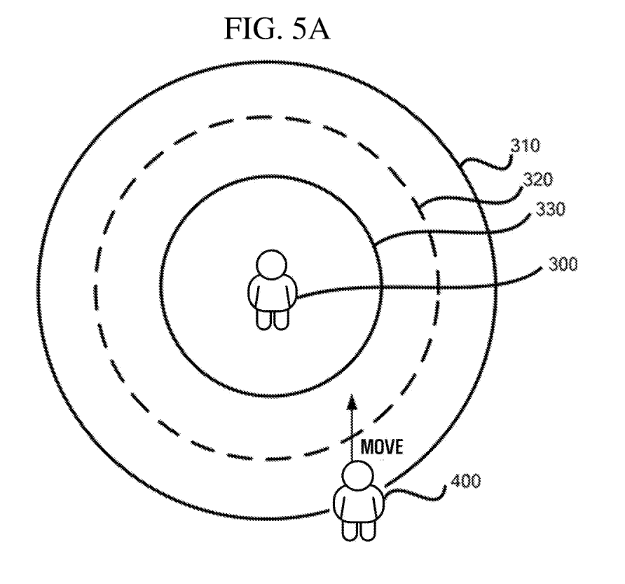

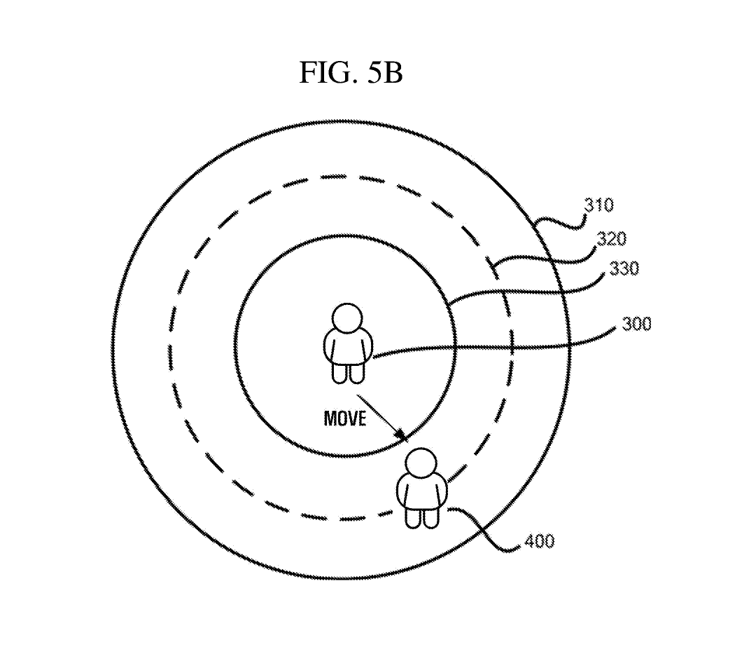

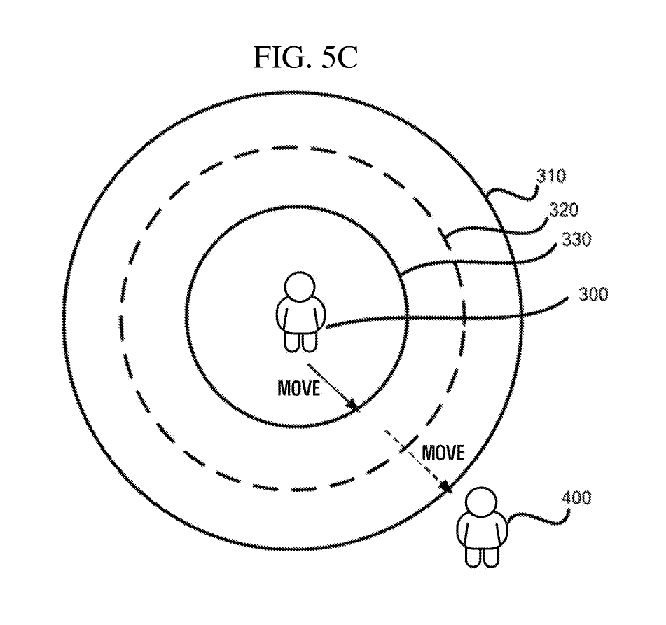

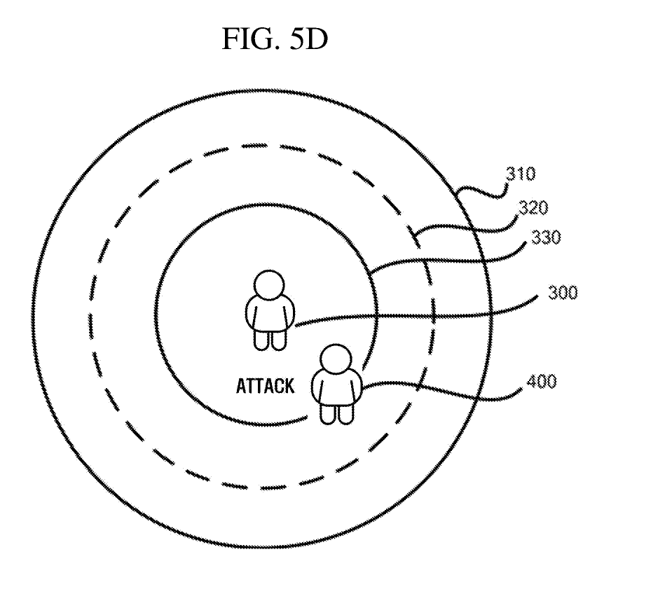

FIG. 4 is a flowchart schematically illustrating a process of processing a method of controlling an automatic attack of a user character according to an embodiment of the inventive concept. FIGS. 5A, 5B, 5C and 5D are reference views for explaining the process of processing the method of controlling an automatic attack of a user character according to an embodiment of the inventive concept.

First, referring to FIGS. 4 and 5A, the game server 200 may identify whether an enemy character 400 entered a detection range 320 of a user character 300 (S10).

The user character 300 may perform an attack when the enemy character 400 is located within the basic attack range 330. However, when the method for controlling an automatic attack is applied to a basic attack, a drive needs to be given to the basic attack such that the user does not pay attention to the basic attack of the user character 300. Accordingly, according to the method for controlling an automatic attack according to the embodiment of the inventive concept, the detection range 320 may be set such that when the enemy character 400 is not within the basic attack range 330 and is located at an outskirt of the basic attack range 330, it may be detected, and through this, the game server 200 may perform a basic attack by chasing the enemy character 400.

Next, referring to FIGS. 4 and 5B, when it is identified that the enemy character 400 entered the detection range 320 but did not enter the basic attack range 320, the game server 200 may move the user character 300 such that the user character 300 chases the enemy character 400 to perform a basic attack on the enemy character 400 (S20).

As described above, because the user character 300 may perform a basic attack only when the enemy character 400 is located within the basic attack range 320 of the user character 300, the game server 200 may try a basic attack of the user character 300 by allowing the enemy character 400 to enter the basic attack range 320 of the user character 300 by moving the user character 300 towards the enemy character 400.

In some embodiments, when it is identified that a plurality of enemy characters 400 entered the detection range 320 but did not enter the basic attack range 330, the game server 200 may move the user character 300 such that one of the enemy characters, which entered the detection range 320, is chased first.

Next, referring to FIGS. 4 and 5C, the game server 200 may identify whether the enemy character 400 deviates from the recognition range 310 while the user character 300 moves to chase the enemy character 400 (S30).

When the enemy character 400 deviates from the recognition range 310 while the user character 300 moves to chase the enemy character 400, the game server 200 may stop the user character 300 from chasing the enemy character 400 (S35).

When the enemy character 400 enters the detection range 320, the user character 300 starts to chase the enemy character 400, but cannot chase the enemy character 400 any more when the enemy character 400 deviates from the field of view of the user character 300. That is, because the user character 300 may chase only the enemy character 400 in the recognition range 310, the user character 300 cannot chase the enemy character 400 any more when the enemy character 400 deviates from the recognition range 310 as the movement speed of the enemy character 400 is higher than the movement speed of the user character 300.

Next, referring to FIGS. 4 and 5D, when the enemy character 400 enters the basic attack range 330 as a result of the movement of the user character 300 (S40), the game server 200 may stop the user character 300 from moving and may control the user character 300 to perform a basic attack on the enemy character 400 (S50).

Because a basic attack may be performed when the user character 300 is stopped in the online game service provided by the game server 200, the game server 200 may stop the user character 300 from moving so that the user character 300 may perform a basic attack and may allow the user character 300 to perform a basic attack when the enemy character 400 enters the basic attack range 320 of the user character 300 due to the chasing of the user character 300.

According to the method for controlling an automatic attack according to the embodiment of the inventive concept, because the basic attack of the user character may be automatically performed while a factor for controlling the basic attack of the user character is excluded from the user interface, the user may concentrate his or her attention on the essential parts of the game without feeling any inconvenience of the narrow user interface of the mobile terminal.

Hereinafter, a process of processing a method for controlling an automatic attach according to another embodiment of the inventive concept will be described,.

Referring to FIG. 4, when a plurality of enemy characters enter a basic attack range 330 as a result of the movement of the user character 300 (S40), the gamer server 200 may stop the user character 300 from moving and may perform a control such that the user character 400 performs a basic attack on one of the enemy characters, which is determined to be attacked first, in sequential consideration of the types of the enemy characters and the distances from the user character and the enemy characters (S50).

For example, when a plurality of enemy characters 400 are located within a basic attack range 330, the game server 200 has to select an enemy character 400, which is to be attacked first, and accordingly, the game server 200 may determine one of the plurality of enemy characters, which is to be attacked first, in consideration of a specific attack priority determined based on the types of the enemy characters, and may determine one of the enemy characters 400, which is closest to the user character 300, as an enemy which is to be attacked first, when the same type of enemy characters 400 are located within the basic attack range 330.

According to the method for controlling an automatic attack according to the embodiment of the inventive concept, because the basic attack of the user character may be automatically performed while a factor for controlling the basic attack of the user character is excluded from the user interface, the user may concentrate his or her attention on the essential parts of the game without feeling any inconvenience of the narrow user interface of the mobile terminal.

The aspect of the inventive concept is not limited thereto, and other unmentioned aspects of the inventive concept may be clearly appreciated by those skilled in the art from the following descriptions.

Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Therefore, the above-described embodiments are exemplary in all aspects, and should be construed not to be restrictive.

What is claimed is:

1. A method for controlling an automatic attack of a user character, the method being performed by a game server, wherein the game server provides an online game service to a mobile terminal connected to the game server through a network and the mobile terminal does not include a user interface for controlling a basic attack of the user character, the method comprising:
identifying whether an enemy character entered a detection range of the user character, wherein the detection range is a range that extends from a basic attack range corresponding to a range in which the basic attack of the user character is allowed; and
when it is identified that the enemy character entered the detection range but did not enter the basic attack range, moving the user character such that the user character chases the enemy character to perform a basic attack on the enemy character.

2. The method of claim 1, further comprising:
when the enemy character deviates from a recognition range while the user character moves to chase the enemy character, stopping the user from chasing the enemy character,
wherein the recognition range corresponds to a range of the field of view of the user character and is a range that extends from the detection range.

3. The method of claim 1, wherein the moving of the user character comprises:
when it is identified that a plurality of enemy characters entered the detection range but did not enter the basic attack range, moving the user character such that the user character chases one of the enemy characters, which entered the detection range first.

4. The method of claim 1, further comprising:
when the enemy character entered the basic attack range as a result of the movement of the user character, stopping the user character from moving and performing a control such that the user character performs a basic attack on the enemy character.

5. The method of claim 1, further comprising:
when a plurality of enemy characters entered the basic attack range as a result of the movement of the user character, stopping the user character from moving and performing a control such that the user character performs a basic attack on one of the enemy characters, which is determined to be attacked first in sequential consideration of types of the characters and distances between the user character and the enemy characters.

6. The method of claim 5, wherein the determining the enemy character which is to be attacked first comprises:
determining one of the plurality of enemy characters, which is to be attacked first, in consideration of a specific attack priority based on the types of the enemy characters, and when the number of enemy characters, which are to be attacked first, is plural, determining one of the enemy characters, which is closest to the user character, as an enemy character, which is to be attacked first.

7. The method of claim 1, wherein the mobile terminal comprises a user interface for controlling a skill attack of the user character, and
wherein the basic attack is performed even though there is no input for the basic attack from the mobile terminal and the skill attack is performed only when there is an input for the skill attack from the mobile terminal.
